(19) United States
(12) Patent Application Publication
(10) Pub. No.: US 2026/0258828 A1
(43) Pub. Date: Sep. 3, 2026

(54) CONTINUOUS FIBER REINFORCED COMPOSITE HARDWARE

(71) Applicant: STE MRAS, LLC, Baltimore, MD (US)

(72) Inventors: Joshua HANNER, Baltimore, MD (US); Mitchell D. SMITH, Bel Air, MD (US)

(21) Appl. No.: 19/552,844

(22) Filed: Feb. 27, 2026

Related U.S. Application Data
(60) Provisional application No. 63/765,089, filed on Feb. 28, 2025.

(51) Int. Cl. F16B 19/10

(52) U.S. Cl. CPC F16B 19/1063; F16B 19/1054

(57) ABSTRACT

A fastener apparatus may include a first part configured to be attached to a second part and the first part may include a polymer including a plurality of continuous fibers that continuously extend from one end of the first part to another end of the first part. In an aspect, the plurality of continuous fibers may be longer than a length of the first part or long enough to wrap fully around a major axis of the part.

### CROSS-REFERENCE TO RELATED APPLICATIONS

This application claims the benefit of United States Provisional Patent Application No. 63/765,089 filed February 28, 2025, the entire contents of which are incorporated herein by reference.

### BACKGROUND OF THE DISCLOSURE

Conventionally, aerospace hardware components, such as fasteners and inserts, are manufactured from metallics and metallic alloys. These aerospace hardware components are used for a variety of attachment purposes including brackets, wire harnesses, piping, tubing and other aircraft systems. In addition, aerospace hardware components are the primary method in attaching structural components together at structural joints. Structural joints carry and transfer loads during operation of the aircraft. The combination of fastener parts such as inserts, locking pieces, etc. in a structural joint may be called a fastening system.

Current alternatives to metallic components include composite materials. Composite materials may include, e.g., a fiber reinforced polymer matrix used in conjunction with metallic or ceramic materials. A fastening system in which one or more fastener parts include composite materials may be called a composite fastening system. Composite fastening systems include one or more fastener part(s) or portions manufactured with composite materials. Advanced composite fastening systems provide exceptional strength-to-weight savings, thermal/chemical resistance, and durability compared to metallics. An additional advantage of composite materials compared to metallics for aerospace applications is that they are inherently creep resistant over their life cycle.

Further, fastening systems may be subject to corrosion if a metallic fastener is used with structural components formed of composite materials, due to the dissimilarity between the composite materials and the metallic hardware. One specific issue lies within galvanic corrosion which can occur, especially in aluminum alloys, when in direct contact with carbon fiber reinforced composites. Alternative metals such as corrosion resistant steel and titanium may be utilized to minimize the risk of galvanic corrosion but result in fasteners which are more expensive to produce and come from a less reliable supply chain.

Advancements have been made to produce hardware manufactured from composite materials but applications remain limited due to their use of discontinuous fiber as the reinforcement and offering limited control in fiber orientation. These limitations are a result of the difficulties associated with manufacturing small complex composite hardware that have prescribed orientations of continuous fiber.

Manufacturing subscale composite parts that have complex geometries typically utilize various molding processes such as injection molding or compression molding. These processes typically utilize a material charge of varying shapes and are comprised of non-continuous fibers (e.g., short and long fiber reinforced composite materials and combinations thereof that do not include continuous fibers). Short non-continuous fiber composite materials typically have random fiber orientations and provide a level of isotropic properties (same in all directions) but lack the critical fiber length required to adequately transfer stress to the fiber reinforcement resulting in low ultimate strength/strain before failure. Long non-continuous fiber composite materials typically have a higher degree of fiber orientation which improves the ability to transfer stress at the expense of their isotropic properties. Combinations of both short and long non-continuous fiber composite materials are a compromise of the isotropic properties generated from random short fiber, and the higher degree of orientation of long fiber composite materials. Regardless of the long and short non-continuous fiber composite material composition, the resulting final orientation is a result of processing dynamics via material flow. The dynamics of the materials and the processing can be unpredictable and are limited by geometry.

Short fiber non-continuous composite parts have fibers that are discontinuous throughout a part. Short fibers typically are classified as having a length of 1 mm or less. Long fiber composite parts have fibers that are simply defined as longer than short fiber reinforcement, however a long fiber part may be discontinuous.

Accordingly, a need exists for composite material systems for aerospace hardware components, among other applications, having greater load capability in design directions and improving the component life cycle, e.g., by reducing material fatigue and creep susceptibility, while avoiding disadvantages such as corrosion and high material/manufacturing costs and supply challenges associated with traditional metallic components. Non-continuous fiber approaches may not achieve the benefits described herein according to exemplary embodiments that include a plurality of continuous fibers.

### BRIEF DESCRIPTION OF THE EXEMPLARY EMBODIMENTS

According to an aspect, the disclosure relates to a fastener apparatus including a first part configured to be attached to a second part. The first part may include a polymer including a plurality of continuous fibers that continuously extend from one end of the first part to another end of the first part.

According to another aspect, the disclosure relates to a fastener apparatus including a first part configured to be attached to a second part. The first part may include a polymer including a plurality of continuous fibers that wraps completely around a center of a longest dimension of the first part.

According to another aspect, the disclosure relates to a fastener apparatus including a first part configured to be attached to a second part. The first part may include a polymer including a plurality of continuous fibers that continuously extend along a single common orientation direction with respect to a central axis of a longest dimension of the first part.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIGS. 1A-1I show exemplary embodiments of oriented and continuous fiber reinforced composite hardware;

FIG. 2 shows a mandrel with a protruding preformed head acting as a solid rivet joining two components through tail deformation from two workable sides, according to the exemplary embodiments;

FIG. 3A shows a mandrel with a countersunk preformed head, for a joint that might see air flow, acting as a solid rivet joining two components through tail deformation from two workable sides;

FIG. 3B shows continuous fiber reinforcement which could be used within the design in FIG. 3A, according to an exemplary embodiment;

FIG. 4 shows a blind style rivet utilizing a composite mandrel with a preformed head, a sleeve, and a locking collar according to the exemplary embodiments, where deformation occurs in the sleeve from the preformed head on the blind side;

FIG. 5A shows a very similar rivet to FIG. 4 but features a countersunk tail for a differing mode of blind deformation as well as a varied locking collar, according to an exemplary embodiment. Presented to show possible alternatives and combinations in design;

FIG. 5B shows continuous fiber reinforcement in the design from FIG. 5A utilizing stack-ups, combinations, and discrete parts with varying fiber orientations according to the exemplary embodiments;

FIG. 6 shows a blind style fastener incorporating a geometric lock according to an exemplary embodiment;

FIG. 7 shows a a combination of designs including geometric locking, blind deformation, and a protruding preformed head according to the exemplary embodiments;

FIG. 8A shows a composite insert acting on its own to provide support in a joint which includes weaker core material according to the exemplary embodiments;

FIG. 8B shows continuous fiber reinforcement which might be utilized in the insert design from FIG. 8A according to the exemplary embodiments;

FIGS. 9A-9G show multiple continuous fiber reinforcement orientations and stack ups within hardware components which are either solid throughout or hollow according to the exemplary embodiments;

FIG. 10 shows a key for illustrating aspects of exemplary fiber orientations according to this disclosure, wherein the exemplary fiber orientations are not the only orientations possible but rather feature a simple way of defining examples in respect to, e.g., a hardware component’s longest axis;

FIG. 11 shows stack-ups combined in sections according to the exemplary embodiments;

FIGS. 12A-12C show braided fiber for off axis support according to the exemplary embodiments;

FIG. 13 shows a free body diagram including three cases of external loading with respect to fastener preload and joint material preload;

FIG. 14A shows a dual access fastener utilizing composite reinforced parts according to an exemplary embodiment;

FIG. 14B shows the exemplary embodiment of FIG. 14A with continuous reinforcement fibers according to the exemplary embodiments;

FIG. 15 shows the exemplary fastener assembly such as shown in FIGS. 14A and 14B including a threaded nut according to an exemplary embodiment;

FIG. 16 shows typical automation constraints for installation of a composite fastener part; and

FIG. 17 shows a cube with continuous reinforcement fiber.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various exemplary embodiments. Each example is provided by way of explanation and is not meant as a limitation and does not constitute a definition of all possible embodiments. It is understood that reference to a particular “exemplary embodiment” of, e.g., a structure, assembly, component, configuration, method, etc. includes exemplary embodiments of, e.g., the associated features, subcomponents, method steps, etc. forming a part of the “exemplary embodiment”.

For purposes of this disclosure, the phrases “devices,” “systems,” and “methods” may be used either individually or in any combination referring without limitation to disclosed components, grouping, arrangements, steps, functions, or processes.

According to an aspect, the exemplary embodiments include oriented and continuous fiber reinforced composite fasteners and inserts for avoiding risks such as corrosion and high material/manufacturing costs and supply challenges presented by metallic fasteners, while providing enhanced properties beyond current composite hardware alternatives.

According to another aspect, the disclosure relates to aerospace hardware components that utilize a polymer (aka, polymer matrix) including a plurality of long continuous fibers to reinforce the structure of the component. The resulting structure allows for controllable fastener designs specific to common joints or for irregular custom cases. The exemplary embodiments include several combinations of fasteners in style and function. The exemplary embodiments may contain a continuous fiber reinforced polymer matrix but are not restricted to that composition and may also be used in conjunction with a variety of materials such as metals/ceramics where required. While the composite aerospace hardware according to the exemplary embodiments is driven by the needs of the aerospace industry, it is also applicable across other industries and other use cases.

Known composite components and fasteners are shown, for example, in US Patent Nos. 4,478,544 and 4,717,302 and Provisional Application No. US63/549089, EP Publication No. 0200400A1, and PCT Publication No . 2015/132766A1.

With reference now to FIGS. 1A-1I, the exemplary embodiments include aerospace hardware components such as composite fasteners and inserts variously including, with reference specifically to FIGS. 1A-1D, fastener parts such as a fastener body 100 having a mandrel 110 and a fastener head 111 and appropriately formed in various geometries depending on the use. Throughout this disclosure, reference to “parts” or “body parts” (or the like) with respect to fasteners or fastener components shall be understood to refer generally to fastener components including of the exemplary embodiments where context makes clear. For example, with reference specifically to FIGS. 1E-1F, the fastener parts include a fastener body 100 formed as a solid rivet 150 in which the mandrel 110 and the head 111 alone effectively form the fastener (discussed further below with respect to FIGS. 2-3B). With reference specifically to FIGS. 1G-1I, the fastener body 100 may be used with other fastener parts such as an insert 160 including a sleeve 120 within which a bore 122 is dimensioned for receiving a correspondingly dimensioned fastener body 100 through the sleeve 120 as discussed further below with respect to FIGS. 4-8B. According to the exemplary embodiments, the sleeve 120 has a sleeve head 123 or portion generally positioned at each end of a mandrel-shaped middle portion 124. The fastener head 111 and the sleeve head 123 may be configured with geometries such as (without limitation) a preformed protruding head 115 or flush head 116, or a resilient head including a geometric lock such as locking arm(s) 118 or a locking clip 119 positioned on prongs 119a that may be defined by a portion of the mandrel 110 divided into opposite, resilient prongs 119a, depending on the particular use requirements.

In an aspect, the exemplary inserts 160 including respective sleeves 120 and bores 122 and the exemplary fastener bodies 100 with which they are used may have complementary and/or corresponding geometries such as, e.g., for portions at which the fastener head 111 is positioned when the fastener body 100 is received through the sleeve 120. Further, with reference back to FIGS. 1A-1D, an additional component such as a locking collar 130 may be used to secure the fastener body 100 within the bore 122 and the locking collar 130 is configured with a complementary geometry to the sleeve 120, bore 122, and/or a locking (or breaking) point 113 of the mandrel 110 to which the locking collar 130 connects. Each of the fastener components according to the exemplary embodiments may utilize an oriented continuous fiber 70 reinforced polymer matrix in various configurations and assemblies discussed further below with respect to FIGS. 3B-9. For brevity in this disclosure, reference to a “fastener” shall include all configurations and components according to one or more respective exemplary embodiments or not inconsistent with this disclosure.

Continuing with reference to FIGS. 1G-1I, a fastener body part or portion such as the mandrel 110, head 111, or sleeve 120 according to the exemplary embodiments extends along a main axis 124 (dashed line). The mandrel 110 and sleeve 120 are longer along the main axis 124 than along a first perpendicular axis 125 (dashed line) that is perpendicular to the main axis 124. In an aspect, the fastener head 111 (or the sleeve head 123) (collectively, “head 111, 123”), for example, is shorter along the main axis 124 than the mandrel 110 or the sleeve 120 is. In another aspect, the head 111, 123 may be longer or shorter than the mandrel 110 or sleeve 120 along the perpendicular axis 125.

With reference now to FIG. 2, the exemplary solid rivet 150 (left) including the mandrel 110 and the protruding head 115 is shown in an exemplary use in a structural joint 210 (middle) joining a first structural component 281 and a second structural component 282. The solid rivet 150 as discussed above includes the fastener body 100 including the mandrel 110 and the head portion 111 and used without the insert 160 or a sleeve generally. While the protruding head 115 in FIG. 2 mechanically engages a top of the first structural component 281, a deformable section 221 of the mandrel 110 extends beyond the bottom of the second structural component 282, and a non-deformable section 222 is positioned generally within the structural joint 210. The deformable section 221 is constructed to allow deformation of the deformable section 221 to form, e.g., a locking deformation 214 (right) that mechanically engages the bottom of the second structural component 282 to mechanically lock the solid rivet 150 in the structural joint 210. To deform the exemplary solid rivet 150 formed from a continuous fiber composite material according to the exemplary embodiments, energy must be applied to the part in some way, as represented by arrows E in FIG. 2 (middle).

With reference now to FIG. 3A, the exemplary solid rivet 150 is shown in use in a structural joint 210 as shown in FIG. 2, except that the solid rivet 150 in FIG. 3A includes a flush head 116 according to an exemplary embodiment. The style of head 111 on the fastener body 100 generally may be adapted to the requisite geometries for particular applications. It is understood that a solid rivet according to the exemplary embodiments—including FIGS. 2 and 3A—may incorporate continuous reinforcement fibers in various geometries and otherwise as set forth in this disclosure.

With reference now to FIG. 3B, the exemplary solid rivet 150 such as in FIG. 3A in use in a structural joint 210 joining structural components 281, 282 is shown. In an aspect, the solid rivet 150 according to FIG. 3B includes a plurality of continuous reinforcement fibers 370. In an aspect, the continuous reinforcement fibers 370 are oriented continuous reinforcement fibers—that is, each individual reinforcement fiber 372 of the plurality of continuous reinforcement fibers 370 is oriented in the same direction through respective body parts such as the mandrel 110 and the flush head 116 (in FIG. 3B). The continuous reinforcement fibers 370 are continuous from end to end of the solid rivet 150. 0-degree mandrel-aligned fiber such as shown in FIG. 3B would provide maximized tensile performance. Continuous reinforcement fibers 370 undergo subsequent deformation within the tail during installation. Individual reinforcement fibers 372 of the plurality of continuous reinforcement fibers 370 each extend continuously (i.e., without a break in the fiber) from one end of a body part or sub-portion of a body part to an opposite end of the body part or sub-portion of the body part, as discussed further below according to various exemplary embodiments. Note that while the figures may show a gap between the ends of continuous reinforcement fibers 370 and an end of the corresponding body part this is strictly for clarity and it is to be understood that the continuous reinforcement fibers 370 extend completely to the ends of the body parts according to the exemplary embodiments. Typically, fasteners and accordingly fastener body parts are less than 10 inches in length.

With continuing reference to FIG. 3B, the continuous reinforcement fibers 370 extend from the bottom end of the mandrel 110 to the top of the flush head 116 as discussed further below. Accordingly, a portion of the continuous reinforcement fibers 370 extends through the deformable section 221 of the mandrel 110 and are similarly deformed when the locking deformation 214 is formed.

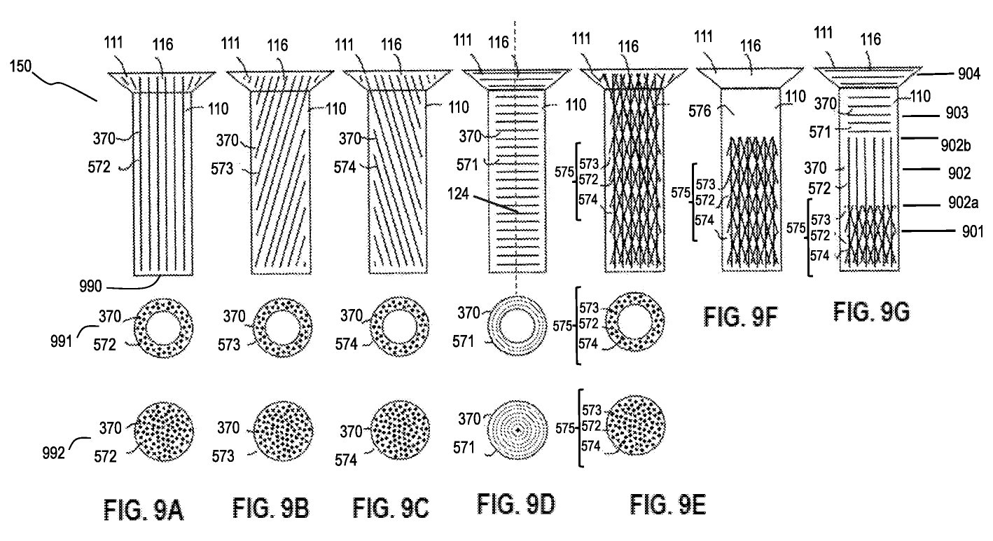

With reference to FIG. 3B and further reference to FIGS. 9A-9C and 9E, the exemplary embodiments include rivets 150 having body parts such as mandrels 110 and heads 111 having a plurality of continuous reinforcement fibers 370 that extend from, e.g., a first end 151 of the rivet 150 to a second end 152 of the rivet 150.

With reference now to FIG. 4, a blind rivet assembly 400 according to an exemplary embodiment includes an exemplary fastener body 100 including a pre-formed protruding head 115 on a mandrel 110 and configured with an exemplary sleeve 120 including a deformable section 221, and a final locking collar 130 at the mandrel breaking point 113. The nature of forming the composite material fastener components including the fastener body 100, the sleeve 120, and the locking collar 130 on their own allows them to be used independently of one another where applicable, such as according to the exemplary embodiments. The fastener body 100—i.e., the mandrel 110 and preformed head 111—without the sleeve 120 and locking collar 130 functionally becomes the solid rivet 150 where tail deformation (e.g., locking deformation 214) from a workable side applies preload. Similarly, the sleeve 120 from the blind rivet assembly 400 when acting on its own becomes the insert 160 providing support for the fastener body 100 containing grip lengths and diameters which are complementarily dimensioned to fit within the insert 160, within the bore 122 of the sleeve 120. Each of the fastener components can be manufactured from oriented continuous fiber (370) reinforced polymers as its own component or as a functional assembly according to the exemplary embodiments.

The exemplary blind rivet assembly 400 includes the insert 160 defined by the sleeve 120 and the bore 122 within the sleeve 120, into which the fastener body 100 functioning as a blind style rivet 440 is inserted. The mandrel 110 extends through the sleeve 120 such that the mandrel breaking point 113 is exposed for connecting the locking collar 130. The bore 122 includes a geometric lock 417 complementarily shaped for the locking collar 130 to lock down (see arrows ‘F’) on the mandrel 110 within the bore 122. As described above, applying force E creates a locking deformation 214 of the deformable section 221 of the sleeve.

With reference now to FIG. 5A, an exemplary blind rivet assembly 500 includes common parts and aspects with FIG. 4 and common aspects will not be described again. The blind rivet assembly 500 in FIG. 5A has a ring-shaped locking collar 130 and a complementary geometric lock 417 on the sleeve 120. The fastener head 111 has a flush head geometry and the bore 122 in the sleeve 120 has a corresponding geometry. The sleeve head 123 has a flush head geometry at the end corresponding to the mandrel breaking point 113. FIG. 5A demonstrates how exemplary features may be alternatives and combinations in embodiments.

With reference now to FIG. 5B (and FIGS. 9B, 9C, 9E-9G, 10, and 11), the exemplary embodiment of a blind rivet assembly 500 shown in FIG. 5A may include continuous fibers 370 oriented for extending through a composite fastener component such as the fastener body 100, insert 160, or locking collar 130, or portion of a composite fastener component in a continuously changing direction to form a helix shape, for example as in FIGS. 9B, 9C, and 10 (theta less than 90 degrees), and FIG. 11 (and portions of components in FIGS. 5B, 9E, 9F, and 9G). The length of each of the oriented continuous fibers 372 is longer than the largest dimension of the corresponding part.

In an aspect, the exemplary embodiments include body parts having a deformable section 221 and a non-deformable section 222, as previously discussed. The deformable section 221 and non-deformable section 222 may be positioned and dimensioned according to particular applications. In an aspect of the exemplary embodiments—e.g., those shown in FIGS. 3B, 5B, and 9A, —the deformable sections 221 of the respective mandrels 110 and sleeves 120 are the sections outside of the structural joint 210 and the non-deformable section 222 is the section within the structural joint 210. With reference to FIGS. 3B, 5B, and 9A, continuous fibers 370 may extend from a first end 222a of the non-deformable section 222 to a second end 222b. However, there may be no continuous fibers in the deformable section 221 as shown in FIGS. 5B, 9F, and 11. A void region 576 is defined by the region containing no continuous fibers. The void region 576 may promote simpler methods of deformation because no fiber reinforcement is present. However, in another aspect, the exemplary body parts may include a deformable section 221 and a non-deformable section 222 both containing a plurality of continuous fibers 370 in a singular or plurality of orientations, as shown in, e.g., FIGS. 3B, 9A-9E, and 9G.

Thus, in an exemplary embodiment, individual fibers 372 may extend entirely from one end to an opposite end of a body part as shown in FIG. 3B. In another embodiment, individual fibers 372 may extend from one end to an opposite end in sections of a finished part as shown in FIGS. 5B, 8B, 9F, 9G and 11 where sections may make up any percentage of the finished part. In another embodiment individual fibers 372 may wrap completely around the longest axis of a part while never reaching an end of the part or section of the part.

With continuing reference to FIG. 5B, the sleeve 120 includes an effective quasi-isotropic stack up 575 with 0-degree mandrel-aligned fibers 572 and +/- 45-degree helical oriented fibers 573, 574 in a section, end to end, from the head 123 until the protruding tail – i.e., deformable section 221. The protruding tail features the void region 576 without fiber reinforcement for ease of deformation. The sleeve 120 may be designed this way to generate high shear strength between the joined components without requiring high tensile performance. The mandrel 110 and head 111 includes 0-degree mandrel-aligned fibers 572 for support in deforming the protruding tail and applying preload. The locking collar 130 features 90-degree hoop-oriented fibers 571 to withstand hoop stresses once installed in the geometric lock 417.

In an aspect, the exemplary embodiments have continuous fibers 370 that are oriented along or around an axis of the component from end-to-end in full parts such as the fastener body 100, insert 160, and locking collar 130, or across sub-sections, stack ups 575, and combinations. A ‘section’ of a hardware component 100, 160, 130 refers to any portion lengthwise along the longest axis from head to tail of a complete component which utilizes a unique orientation of fiber 370 reinforcement (or lack of fiber reinforcement) from another section as seen in FIGS. 5B, 8B, and 11. A ‘stack-up’ refers to any internal portion of a full component 100, 160, 130 or section where unique fiber 370 orientations are stacked outward from the center of the longest axis along the radius as seen in FIGS. 5B and 11. For example, if in one section of a part multiple fiber 370 orientations are required, a stack-up of varying fiber 370 orientations extending outward along the radius would be utilized. A ‘combination’ refers to any parts 100, 160, 130 containing a mix of sections and stack-ups as seen in FIGS. 5B and 11. For example, if a fastener requires a non-deformable sleeve comprising a stack-up but a deformable tail void of fiber 576 then a combination of stack-ups and sections may be utilized such as shown in FIG. 5B.

Continuous fiber 370 reinforcement is controllable in orientation/stack-up 575 and is continuous, achieving maximized performance of a composite material system in a small complex geometry. Continuous fiber 370 orientation can wrap helically from a 90-degree (perpendicular to the mandrel) hoop orientation 571 to straight 0-degree (parallel to the mandrel) axial orientation 572 including any ± θ-degree helical orientation 573, 574 in-between. FIGS. 9A-9G, 10, and 11, contain primary representations of the continuous fiber 370 orientations described. The nature of manufacture also allows stack-ups 575 of cylindrical orientations to maximize net performance. Where parts may require ease of deformation 214 for mechanical fastening, sections may be created resin rich (such as in void region 576) to enhance ductility and formability. Any combination of continuous fiber 370 orientation, stack-up 575, or void region 576 within the presented parts is possible. The presented continuous fiber 370 orientations are best described from 0-degree mandrel-oriented fibers 572 to 90-degree hoop-oriented fibers 571 with any helical orientation 573, 574 in-between possible, but it must be noted that other variations of continuous fiber 370 orientation can be generated beyond what is described in the above figures.

For example, as shown in FIG. 17, if a cube 1600 with principal axes x, y, z is presented, continuous reinforcement fiber 370 orientation can be continuous and controlled unidirectionally or multi-directionally in any out of plane axis 1, 2, 3.

The continuous reinforcement fiber 370 orientation may follow any out of plane axes (1, 2, 3) with some angle change (alpha, beta, gamma) with respect to the part’s principal axis (x, y, z) at that point as seen in the far-right image. For a mandrel with purely 0-degree fibers 572 the fibers’ axis would be parallel to the principal orientations as seen in the middle image. For defined fiber orientations (0-degree, hoop , helical) at an infinitesimal point the continuous reinforcement fiber 370 orientation is determined through angle changes with respect to the principal axis. For example, helical orientations are multidirectional but at an infinitesimal point of the part the helical orientation can be defined in a single direction.

Manufacture does not limit off axis fiber support to helical orientations. Helical continuous reinforcement fiber orientation 573, 574 is an example of multi-directional fiber orientation not bound to a part’s principal axis. Similarly, continuous reinforcement fiber 370 can be used in combination with any short/long fiber additive or combined in sections with short/long fiber. The exemplary embodiments including the fastener body 100, insert 160, and locking collar 130 utilizing continuous fiber 370 support do not require 100% continuous fiber reinforcement. The exemplary embodiments which do not utilize 100% continuous fiber reinforcement are created with varied sections to meet functionality requirements, such as the void region 576 as seen in FIG. 5B.

The exemplary embodiment described in detail based on FIG. 5B, includes the blind-style rivet 500 utilizing a variation of continuous fiber 370 orientations and stack-ups 575 in sections and combinations of discrete parts including the fastener body 100, insert 160, and locking collar 130 for a joint that witnesses high shear loads with minimal tensile loading. A stack-up 575 of 0-degree mandrel-oriented fibers 572, ± 45-degree helical fibers 573, 574, and a resin rich void of fiber region 576 at the end of the sleeve 120 for deformation 214 may be utilized. The nature of oriented continuous fiber 370 reinforcement in the presented blind rivet 500 will maximize the ultimate shear strength while allowing ease of deformation 214 in the deformable section 221 that does not have high tensile strength requirements. The mandrel 110 may utilize simple 0-degree mandrel-oriented fibers 572 to provide support and maximize its ability to deform 214 the deformable section 221 within the tail of the sleeve 120 during installation. A small part locking collar 130 may utilize 90-degree hoop-oriented fibers 571 to withstand hoop stresses within the lock point (i.e., breaking point) 113 during and following installation. Within the flush-head-style 116 head 123 of the sleeve 120 and the preformed head 111 of the mandrel 110, continuous fibers 370 may splay outward along the head 123, 111 in a controllable fashion. Orientation will change in fiber splay-out within any change in geometry but may remain largely aligned with a determined direction. Any other combination of continuous fiber 370 orientation and stack-up 575 from 0-degree 572 to 90-degree 571 is possible in any location of the described parts including the fastener body 100, insert 160, and locking collar 130. The presented example would allow production of parts 100, 160, 130 marked as ‘shear-style’ blind rivets (e.g., 400, 500) with varying grip lengths, diameters, head styles, etc. to garner net usage in particular markets where the demand is present.

With reference now to FIG. 6, a mandrel 110 with a preformed head 111 including ‘umbrella’ arms 118 which are slightly compressed and pushed through the sleeve bore 122 also including a countersunk head 123. Once fully installed within the joint 210 the arms 118 expand and can be locked in place on a blind side 440 through a pulling force E and geometric lock on the workable side. The size of preformed arms 118 is not necessarily to scale.

FIG. 6 shows a blind rivet assembly 600 substantially similar in concept to those shown in FIGS. 4, 5A, and 5B, (for example and without repeating descriptions). In FIG. 6 a geometric lock 617 can be achieved through the rigidity of composite components such as arms 118 which may flex slightly (see arrows G’) inward through a sleeve bore 122 under a force G, and form the geometric lock 617 in place once joined. The high stiffness in composite materials creates challenges in utilizing this method but provides a high level of rigidity once in place. Opposing forces E’ and F may break the mandrel at the breaking point 113, secure the geometric lock 617, and form a locking deformation 414 at the top of the mandrel 110.

With reference now to FIG. 7, another exemplary embodiment of a blind rivet assembly 700 is shown in which common features will not be repeated. As with FIG. 6, the mandrel 110 with preformed locking mechanism including compressible components is pushed through a sleeve and expands once fully through. More specifically, through a pulling action and locking mechanism the locked arms can deform the blind side sleeve. In FIG. 7, the exemplary embodiment of a fastener body 100 includes a head 111 with the resilient clip 119 at the end of the prongs 119a. The resilient clip 119 and prongs 119a are passed through the sleeve 120 under the force G and forms a blind style rivet 440 at a point in which the resilient clip 119 emerges from and engages a bottom of the sleeve 120 where it forms a geometric lock 617 before the deformable section 221 of the sleeve 120 is formed into a locking deformation 214.

As also shown in FIG. 7, another form of geometric lock can come from a locking collar 130 (previously discussed) which is designed such that it is pressed into place when a mandrel 110 is broken at the breaking point 113 post installation to provide an additional level of safety. Where a geometric lock is not desired, a locking deformation 214 can be utilized to generate a mechanical lock in a variety of ways as seen, e.g., in FIGS. 2, 3A, 3B, 4, 5A, 5B, and 7. To form a locking deformation 214 in a composite material, energy must be applied to the part in some way. Examples include heat generated through friction, heat generated through electrical currents, ultrasonically, etc. The nature of polymers utilized is a consideration in the function of a locking deformation 214.

With reference now to FIG. 8A, the exemplary insert 160 is shown as part of a composite fastening system 800 joining structural components 281, 282 with a core material 881 sandwiched between the structural components 281, 282. A fastening system at a structural joint (e.g., 210) in which the core material 881—especially a weaker core material—is in a sandwich construction between structural components 281, 282 may use an insert 160 as a supporting feature to prevent the core material 881 from being crushed where a fastener generating high levels of preload may be installed. The exemplary insert 160 formed from reinforced composite material (continuous reinforcement fibers 370) according to this disclosure provides enhanced structural support compared to metallic inserts and is not subject to corrosion where the structural components 281, 282 or the core material 881 are formed from composite materials.

Where other figures show a mandrel 110 and preformed head 111 acting as a solid rivet 150, FIG. 8A shows a sleeve 120 working independently as an insert 160. It would be possible to use this embodiment in conjunction with a composite or metallic fastener where desired. The insert 160 in FIG. 8A provides support for a sandwich construction utilizing honeycomb core 881 which will be joined with a subsequent laminate 281, 282 using a fastener (i.e., sleeve 120) which applies high preload. The insert 160 must display adequate pull through resistance, pre-load capability, and bearing strength at a tail 820. 0-degree mandrel-oriented fibers are utilized to provide pull through support at the head 123 and retain rigidity under the applied preload. 90-degree hoop-oriented fibers 571 (FIG. 8B) are utilized to maximize bearing strength in the tail at the bearing contact location with the sandwich panel face sheet.

With reference now to FIG. 8B, the exemplary composite fastening system 800 shown in FIG. 8A is shown including an exemplary orientation of continuous fibers 370 in which, in a first section 120a of the sleeve 120, continuous fibers 370 are oriented at 90-degrees 571 relative to the major axis 124 of the insert 160. In a second section 120b of the sleeve 120, continuous fibers 370 are oriented at 0-degrees 572 relative to the major axis 124. In the flush-head-style 116 sleeve head 123, the continuous fibers 370 splay out according to the flush head 116 shape.

With reference to FIGS. 9A-9D, the exemplary embodiments include solid rivets 150 as discussed above with mandrels 110 and heads 111 such as flush-head-style 116 heads and having a plurality of continuous reinforcement fibers 370 that are arranged along a single common orientation direction (e.g., a straight vertical direction 572 (FIG. 9A), a helical direction 573, 574 (FIGS. 9B, 9C), or a perpendicular direction 571 (FIG. 9D)) with respect to a central axis—which may be the main axis 124—and is the longest dimension of the body part, such as in FIGS. 9A-9D. From left to right the figure features mandrel-aligned fibers (9A), + θ-degree helical fibers (9B), - θ-degree helical fibers (9C), hoop fibers (9D), a ‘ply’ stack-up of mandrel and +/- θ-degree helical fibers (9E), another stack-up featuring a resin rich tip void of fibers (9F), and an example of a combination of the prior examples (9G). Fiber orientation is highly controllable in embodiments of the presented hardware. The bottom two rows within FIG. 9 display views from below the presented embodiments displaying cross sectional views of fiber orientation within a body part of the component in hollow (upper row) or solid (lower row) configurations. For each of FIGS. 9A-9E, a side view of the corresponding exemplary rivet 150 is shown with respective end views 990 showing embodiments in which the composite reinforcement fibers 370 form an annular (hollow) part 991 versus a solid part 992. In an aspect, the exemplary embodiments shown in FIGS. 9A-9G (among others) include a head 111 having a different shape (i.e., flush-head-style 116) than the mandrel 110, and the continuous reinforcement fibers 370 extend from the mandrel 110 into the head 111. The continuous reinforcement fibers 370 remain continuous throughout the head 111 of the component and may splay out or follow a corresponding geometry of the head 111 such as in FIGS. 9B, 9C, and 9D, in controlled orientation.

With reference now to FIGS. 9E-9G, the exemplary solid rivets 150 may include body parts such as mandrels 110 and heads 111 that include a plurality of continuous reinforcement fibers 370 arranged along a number of orientation directions in different sections of the respective solid rivets 150. FIG. 9F, for example, includes a stack-up 575 orientation as previously discussed, and also includes a void region 576 such that the continuous reinforcement fibers 370 do not extend past the void region 576 or into the head 111. In FIG. 9F, the solid rivet includes a stack-up 575 orientation in one section, a parallel (0-degree) orientation 572 in a second section, and a perpendicular orientation 571 in another section. In an aspect, the number of orientation directions 571, 572, 573, 574 present in a composite fastener part according to the exemplary embodiments or otherwise not inconsistent with this disclosure is less than or equal to five, more specifically less than or equal to three. Even more specifically, the number of orientation directions is less than or equal to two.

With reference now to FIGS. 9D and 10, the exemplary embodiments include continuous reinforcement fibers 370 that extend in a hoop orientation 571, that is, a curved direction in a plane normal to the main axis 124 of the fastener body part (e.g., theta equal to 90 degrees). Each of the oriented continuous reinforcement fibers 370 extends at least long enough to make a full wrap around the main axis 124 of the fastener body part.

With specific reference to FIG. 9G, an exemplary composite fastener body part—e.g., solid rivet 150—includes a plurality of sections such as first, second, third, and fourth sections 901, 902, 903, 904 defined by a different load or stress requirement (or geometry) at each section. The continuous reinforcement fibers 370 within each section have a length equal to or longer than a dimension of the corresponding section. For example, as shown representatively for the second section 902, the length of the continuous reinforcement fibers 370 between a first section boundary 902a and a section boundary 902b is equal to or greater than the length of the second section 902 defined between the first section boundary 902a and the second section boundary 902b along the main axis 124. However, the dimension against which the length of the continuous reinforcement fibers 370 are compared may extend along the longest axis of the body part or portion, which may be, e.g., the main axis 124 or a perpendicular axis 125 of the body part or portion, or along any other direction required based on the load or stress.

Continuous reinforcement fibers 370 according to the exemplary embodiments have a length equivalent or greater than the length of the corresponding composite hardware or part or subsection of the composite hardware they reinforce with no break in the end-to-end fiber reinforcement. Continuous reinforcement fibers 370 according to other embodiments may be completely oriented in a plane normal to the longest axis such as the main axis 124 of a composite fastener part and may not satisfy having a length which is equivalent or greater than the part they reinforce but instead satisfy a length which completes a full wrap around the longest axis such as the main axis 124. For example, the mandrel 110 according to the exemplary embodiments with 0-degree mandrel-oriented fiber reinforcement 572 will have fiber length equivalent (or greater than, as consistent with this disclosure) to the length of the mandrel 110, 90-degree hoop-oriented fiber reinforcement 571 will have fiber length which satisfies a complete or greater wrap in a plane normal to the longest axis of the mandrel 110, and ± θ-degree helical oriented fiber reinforcement 573, 574 will have a fiber length greater than the length of the mandrel 110 due to the wrapping geometry.

Continuous reinforcement fiber 370 maximizes stress transfer to continuous reinforcement fibers 370 contributing to enhanced strength/strain properties before failure. Continuous reinforcement fiber 370 is highly anisotropic (different properties in different directions) which limits properties in transverse directions. Utilizing stack-ups 575 of continuous reinforcement fibers 370 allows creation of composite fastener parts with essentially quasi-isotropic properties for general use cases where parts are loaded in multiple directions. Fully anisotropic behavior can be utilized when composite fastener parts may witness high levels of stress in primary directions. For example, a joint with extreme tensile strength requirements and low shear requirements could utilize corresponding entirely 0-degree mandrel-oriented reinforcement fibers 572.

FIG. 11 shows, for example, a helical fiber orientation 574 stacked with mandrel-oriented fiber 572. These are then combined with a void region 576 void of fiber. FIG. 11 does not display various complex geometries but illustrates, without limitation, sections, stack-ups, and combinations according to this disclosure.

Embodiments of the composite fastener parts include styles for typical load-case structural joints 210, i.e., maximize for shear, tension, compression, bearing, pull through, etc. Where structural joints 210 see irregular/non-uniform loading the continuous reinforcement fiber 370 orientation, raw materials, and geometries can be chosen for specific application as a custom alternative. Geometry of head styles 115, 116, 118, 119, mandrels 110, inserts 160 including sleeves 120, and locking collars 130 play a crucial role in aerospace joints. Protruding heads 115 present benefits where simple and easy to form components are allowed. A main constraint arises on air flow surfaces where drag must be minimized using countersunk flush heads 116. This can either occur on one side of a structural joint 210 where a countersunk head 116 is required for single side airflow or on two sides of a structural joint 210 as a double flush system for dual airflow. Embodiments requiring flush heads 116 may be obtained from initial part fabrication or through final installation locking deformation 114. Embodiments variously include complex geometries in composite fastener parts allowing for multiple modes of mechanical fastening.

A mechanical fastener typically joins two or more components 281, 282 through a level of preload which supports and retains its mechanical lock under a variety of applied loads. The exemplary embodiments of composite fastener parts described within this disclosure when acting as a fastener allows simple geometric locking, e.g., 617, tail side 214 or head locking deformation 414, or any combination of prior parts which may act together or alone.

The use of polymer matrices that allow for composite fastener parts locking deformation 214 is due to the fact that the matrix is deformable. Common examples of deformable polymer matrices which can be used include, but are not limited to, nylon, polycarbonate, polyether-ether-ketone, thermoplastic polyimides, thermosetting-thermoplastics, staged thermosets, etc. Choice of the polymer matrix is dependent on its application and thermal, chemical, and moisture resistivity. The continuous reinforcement fiber 370 of the composite fastener parts can be chosen based on application as well including, glass, aramid, carbon, etc. As an example, a choice for an aerospace application would include a carbon fiber reinforced PEEK matrix around ~50% V_{f} for its exceptional properties in chemical and temperature resistance under high loads. In cases where special requirements must be met the composite components can be manufactured with additions of various materials. Design is not limited to 100% composite components. Composites can be joined with any bare plastic (thermoset/thermoplastic), ceramic, metal, or other material as an assembly of composite fastener parts with discrete materials or in conjunction with each other as a multi-material component through surface treatment, bonding, etc.

The exemplary composite fastener parts described and presented in figures showcase smooth finishes but the disclosure is not limited to smooth finishes. This effectively showcases styles of rivets 150 (i.e., fastener bodies 100) and inserts 160. All composite fastener parts presented or not otherwise inconsistent with this disclosure can be finished in various manners or threaded to create variations in threaded fasteners such as nuts, bolts, screws, washers, etc.

Further systems, especially ones with continuous fiber reinforcement, offer excellent tensile performance in the direction parallel with fibers (longitudinal) and flexural properties when bent longitudinally, but significantly reduced properties when loading is applied from an axis perpendicular to the fiber orientation (transverse) in direct tension, compression, or a through a shear plane. For a composite fastening or retention system this can be important to the design of the system based on stress requirements, and fastener/hardware type.

Existing fastener types, especially in the aerospace industry, are designed to carry either primary shear or tensile loads. For a shear type fastener or hardware component loaded between two or more parallel joint structures, there are two primary critical load cases. These two primary critical load cases are the through-thickness shear plane created from clamped joints with no gaps and the compressive bearing contact area. The through-thickness shear plane created between clamped joint material is detrimental because the composite system is not allowed to bend out of plane to gain benefit of the axial / longitudinal fiber reinforcement in flexure. Additionally, the bearing contact region generates off axis compressive stress to the hardware component loaded in shear.

Composite hardware is primarily designed for use in composite structures. In the aerospace industry fastened composite joints are designed such that failure occurs in the surrounding composite material and not the fastener. This is because bearing failure of the laminate is much more contained and less explosive than net fastener failure where the loss of critical fasteners may fully fail the structure leading to separation. Therefore, in order to drive bearing failure of a composite joint with composite hardware the hardware must be just strong enough to cause initial bearing failure of a laminate before failing in shear. The amount of load required to cause failure in the laminate is dependent on the diameter of the fastener and the thickness of the laminate which combine to create the effective stress area (rectangular area equal to the fastener diameter multiplied with the laminate thickness) where the greater the bearing stress area the greater shear capability a composite hardware component must have.

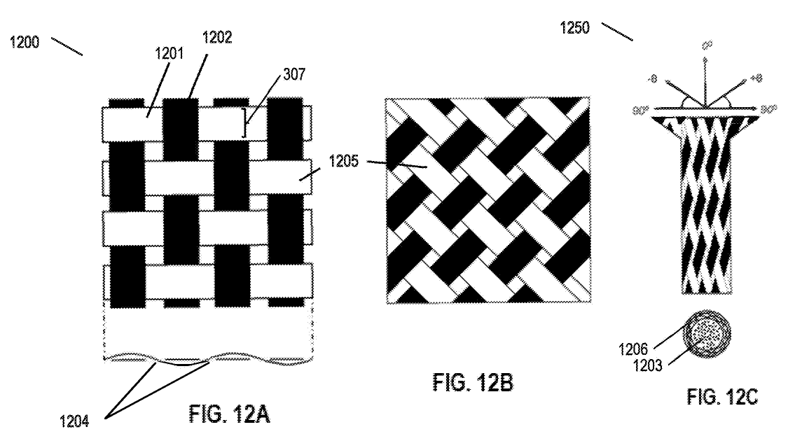

With reference now to FIGS. 12A-12C, exemplary embodiments of a composite braided architecture 1200 are shown according to the disclosure. The braided architecture according to FIGS. 12A-12C is a flat fiber architecture 1200. The flat fiber architecture 1200 includes two distinct orientations of woven flat fibers 1201, 1202 in a single plane and having a braided-style architecture. In other words, not extending radially away from a core material 1203 (FIG. 12C) at each orientation of continuous reinforcement fiber 370 in a stack-up 575. Micro bending or kinks 1204 exist in the flat fiber architecture 1200 of a braided/woven type structure. The number of fiber orientations in a single plane can exceed two for quasi-isotropic properties in a single plane. Each rectangle, e.g., 1205, depicted in FIGS. 12A-12C represents continuous reinforcement fibers 370 formed into the flat fiber architecture 1200. The woven flat fibers 1201, 1202 are depicted as rectangles because fibers are typically braided in tows or bundles where a plurality of continuous fibers are represented by one rectangle.

FIG. 12B shows the flat fiber architecture 1200 rotated 45-degrees from the orientation shown in FIG. 12A. The exemplary embodiments containing, without limitation, braided fibers are constructed to provide off-axis support for shear loading where continuous fiber reinforcement 370 should help carry loads perpendicular to the composite fastener part’s main axis 124 at +/- θ-degree helical orientations. Continuous fiber reinforcement 370 remain continuous from end to end.

FIG. 12C shows an embodiment of a solid rivet 1250 in which a fastener body (e.g., 110) acting by itself forms the solid rivet 1250. The solid rivet 1250 is formed entirely from braided fibers such as the flat fiber architecture 1200. In an aspect of the exemplary embodiments referred to as “braided” it is understood that woven flat fibers 1201, 1202 wrap helically continuously from one end to another in a composite fastener part or subsection. In an aspect, the solid rivet 1250 may include a flat fiber architecture layer 1206 over the core region 1203 (see FIG. 12C). The embodiments include +/- θ-degree helical fiber orientations in the single braided layer—flat fiber architecture layer 1206—encapsulating the axially-aligned continuous reinforcement fiber core 1203. In some embodiments, a composite fastener component may be formed entirely from a braided architecture such as flat fiber architecture 1200 if the final composite fastener component is hollow, such as an insert 160/sleeve 120, nut, washer, or the like.

To boost the rigidity and ultimate shear strength of a composite fastener part to drive laminate bearing failure prior to the shear, in an aspect of the exemplary embodiments, off-axis fibers such as the +/- θ-degree helical orientations 573, 574 can be used including in sections, stack-ups 575, or combinations therefrom. In sections, stack-ups 575, and combinations, each fiber orientation becomes a discrete layer at some radial distance perpendicular to the hardware component’s longest axis. Discrete radial stack-ups 575 allow freedom of design in each layer such as in a unidirectional flat laminate where the full stack-up 575 can be defined by any combination of orientations from one face of a laminate to another. The (braided) flat fiber architecture 1200 has a level of quasi-isotropic performance across the whole cross-sectional area of a corresponding rivet 1250 (FIG. 12C), for example, for ease in shear analysis and reduce variability in shear strengths. In an aspect, the two or more fiber orientations 1201, 1202 occur radially 1206 around the core material 1203 with its own fiber orientation. In embodiments with discrete +/- θ-degree helical fiber orientations require, at a minimum, three sections in a stack up 575 to produce a composite fastener part with an axial aligned core, a +45-degree helical section, and a -45-degree helical section. The braided flat fiber architecture 1200 requires only two sections in a stack up to produce a composite fastener part with the foundational fiber architecture while also leaving the final part with both off axis (i.e., positioned away from a central axis of the part) fiber orientations 1201, 1202 in a homogenized section extending from the axial core 1203 radially to the outer surface of the part.

Discrete +/- θ-degree helical fiber reinforcement may provide enough quasi-isotropic off axis support without any in-plane bending or kinks in the continuous reinforcement fiber 370 structure. Embodiments including braided reinforcement (e.g., flat fiber architecture 1200) will always include in-plane bending and kinks 1204 in the flat fiber architecture 1200 due to the necessary braided/woven type structure. Braided fibers must weave in and out of the other orientation(s) creating the micro-bends 1204 in the structure rather than entirely helical orientations. Additionally, as previously discussed, exemplary embodiments do not always contain smooth surfaces such as the rivet/insert designs. In an aspect, threads, steps in diameter, swaging elements, or other similar structures may need to rely on a discrete fiber orientation within the designed composite fastener part. For example, an exemplary embodiment containing threads may inherit greater retention with a single θ-degree helical fiber reinforcement following a thread path than with a braided architecture such as the exemplary flat fiber architecture 1200.

With reference now to FIG. 13, a joint 210 as a free body diagram is shown featuring three different cases of external loading with respect to fastener preload and joint material preload. In an aspect of the exemplary embodiments, composite fasteners and parts rely on generated preload and retention over a lifecycle of the parts to avoid joint separation. Joint separation occurs at some external load greater than the initial joint preload where the only forces are the fastener preload and joint preload acting in equal and opposite directions. Preload acts to clamp the joint together and retain this during external loading to prevent fatigue failures and other undesirable load conditions which occur after joint separation.

With reference now to FIG. 14A (and common features discussed above), a dual access fastener 1400 utilizing composite reinforced parts—e.g., an insert 160 having a sleeve 120, fastener body 100, locking collar 130, and a washer or nut 1410. FIG. 14A shows an exemplary embodiment in which the mandrel is pulled (arrows) in tension and a flush-style 116 sleeve head 123 flare is made on the sleeve 120 to form an installed countersunk head at an angle less than 90-degrees from the composite fastener part longest axis while subsequently breaking the center mandrel 110 at the locking point 113 and locking tension/preload into the structural joint 210 for retention. The exemplary embodiment shown in FIG. 14A may utilize various combinations from the exemplary embodiments of composite fastener parts and the arrows show the tension locked in the fastener with equal and opposite clamp left in the structural joint following final installation.

With reference now to FIG. 14B, the exemplary embodiment of FIG. 14A is shown with continuous reinforcement fibers 370 shown in each of the insert 160, fastener body 100, and locking collar 130. In an aspect, FIG. 14B shows 0-degree mandrel-oriented 572 composite reinforcement fibers 370 except in the locking collar 130 which features the typical 90-degree hoop oriented fibers 571 to retain primary locking forces. Various combinations of continuous reinforcement fiber 370 orientations may be used in various sections, stack-ups, braided architectures, and combinations therefrom, as consistent with this disclosure.

With reference now to FIG. 15, composite fastener assembly such as shown in FIGS. 14A and 14B is shown including a threaded nut 1510 for enhanced preload generation, obviating the need for a locking collar 130 for a fully consolidated and retained preload through a flared head 1515. The exemplary embodiment includes threads 1511 to generate the preload due to the fact that threads and similar features are more susceptible to preload-loss, creep, and fatigue. The threaded nut 1510 creates a tension (arrows) with the fastener body 100 and flush-style 116 head 111. For a thermoplastic mandrel the tail 1512 is heated and formed into the flared head 1515 at a point past the threaded nut 1510 in the direction normal to the joint surface such that the application of heat does not cause the threaded nut 1510 to lose the initial tension generated. Upon cooling the threads 1511 are locked in place and flared head 1515 and the fastener body 100/mandrel 110 carry all tensile and creep/fatigue capability while retaining the preload. In other embodiments, a similar flared head for retention could be applied such as over a locking collar 130.

With reference now to FIG. 16, typical automation constraints that should be considered where installation of a composite fastener part occurs with some end effector of a robotic system working in an open shop space. The side of the part opposite the end effector is limited by either part geometry, shop space, or the fact that needing two sides for installation requires more complex systems. It is important that the opposite side is not always completely blind where automation is still possible with dual sided access and largely one sided installation of a wet installed fastener or similar embodiment.

Final preformed head orientations are a result of manufacturing constraints. For both tensile and shear style fastener systems according to the exemplary embodiments, including primary hardware components, the ability to preload a fastened joint and retain a clamping force is critical to the lifecycle of the fastener as well as the joint/part especially in aerospace joints with requirements for fatigue, vibration, etc. A hardware component must fundamentally function in some way that clamps the joint material and retains this clamp throughout a given lifecycle to some degree. Preload is achieved in metallic fasteners and hardware components through various means based on the design of the component and installation while taking advantage of material properties. Preload is not a function of the material itself, but rather the design and installation which might gain some benefit based on the material properties. Tensile loads in aerospace fastened joints are designed around the preload to avoid separation of the joint. FIG. 13 includes a model of a fastened joint with the primary acting forces – joint separation does not occur until an external load greater than or equal to the initial fastener preload assuming proper retention. The typical value of preload or clamp up from a fastener occurs on a slider bar somewhere between 0 lbf and the yield strength of the mandrel, threads, or other geometry carrying the initial load. Therefore, a typical value is difficult to define depending on exact constituent materials in the composite system as well as varying designs. On the low end of preload, small diameter solid rivets (~3/16”) typically produce a variable preload of about 100 lbf, whereas tensile nuts and bolts may produce exceptional preload exceeding 1000+ lbf. The exemplary embodiments may maintain low end preloads or exceedingly high preloads in the same manner based on material capability and geometry/installation.

For example, the exemplary embodiments may include continuous fiber reinforced solid rivets with a shop formed head during installation. In a metallic solid rivet, the primary load case is shear because the preload is so inherently low, but the preload remains important to the fastener and joint. A degree of preload is generated through elastic recovery of both the rivet material and the clamped joint. When a solid rivet is bucked its mandrel expands filling the through-hole of the joint creating friction between the surface of the mandrel and the joint material to resist tensile loads, a compressive force to the joint material, and significant deformation of the tail or shop formed head. The joint material is held in compression, and the rivet is held in tension as it tries to elastically snap back following significant plastic deformation – resulting in equal and opposite preload in the joint system due to elastic recovery and further retention carried by friction resistance to external tensile loads at the hole/fastener contact region. A metallic solid rivet and joint is held in preload based on the design of the fastener, installation forces, ability of the material to deform, and takes advantage of elastic recovery.

For embodiments including continuous fiber reinforced composite hardware preload is equally dependent on the design and installation, but the material behaves differently from metallic counterparts. Therefore, certain embodiments requiring deformation such as the solid rivet installation must feature functionality to generate equivalent or better performances as desired (specifically when relying on a deformation alone). Existing composite alternates which simply mimic metallic hardware form and function do not behave in the same manner and cannot create the same capability and as such leaves improvements to be made as presented with the exemplary embodiments.

For example, continuous reinforcement fibers 370 within the embodiments shown in FIG. 3B are shown to fold over into the joint material at 180-degrees in the shop formed head to demonstrate a separate advantage gained from the use of composite materials in a hardware component. To create a shop formed head within a composite solid rivet a level of energy must be applied through conduction heating or similar to excite the material into a rubbery or flow state; though this creates a challenge in generating preload in the system as material in a flow state cannot pull net tension on the fastener to clamp the joint sufficiently following installation. By controlling fiber orientation through installation, the fastener gains a CTE advantage of the material that is not possible in metallic hardware. The longitudinal CTE of carbon reinforced polymer systems may be negative resulting in shrinkage during a heat cycle and expansion during cooling (opposite of a standard metallic part). For a local and controlled shop head forming process the shop formed head according to the exemplary embodiments can expand into the joint material during cooling creating equal and opposite preload in the joint system which is further retained by end-to-end continuous fiber reinforcement in a clamped system (through controlled fiber reinforcement during installation and proper constituent materials such as a carbon fiber reinforced PEEK matrix). If allowable in a joint configuration in some embodiments the joint material might also be compressed during installation such that the elastic recovery of the joined material creates preload in the system once the fastener is cooled in an installed state, though significant transverse compression in a composite joint is less desirable and applicable compared to metallic joints that metallic solid rivets are typically used in.

Embodiments are not limited to the prescribed angle(s) in FIG. 3B or otherwise. For example, a shop formed head may create a flare into a countersunk nut or washer at a shallower angle less than 90-degrees from the part’s longest axis to capture and retain preload while promoting tensile capability as discussed with respect to, e.g., FIGS. 14A-15. Embodiments controlling fiber orientation in shop formed heads to an angle less than 90-degrees from the part’s longest axis during installation are referred to as “flared” and embodiments of this kind may contain a flared head on either side of the composite part or both sides with embodiments featuring no initial manufactured head. Flares may be generated through center pins or end effectors (e.g., 1516, FIG. 15) for in-situ molding of shop formed heads. Support features such as washers, nuts, or otherwise are desirable for these embodiments to support angles of less than 90-degrees without an additional countersink in the joint material, allowing a backing for the head to form to, and promoting a degree of bonding depending on the polymer matrix and installation method used.

The exemplary embodiments may include threads, mechanical lock points, swaging elements, and other similar features. Such mechanical features may be compatible with metallic hardware, especially when combined with a second form of retention for aerospace use to meet aerospace mechanical fastener requirements outlined from the FAA/EASA (requiring two forms of retention for non-permanent fasteners). For fiber reinforced polymers the same features may be generated but typically lack full capability of the fiber reinforcement due to sharp geometry changes in an anisotropic system. Where fiber reinforcement bends at sharp angles due to geometric changes or flow parallel with a shear plane (such as in threads or a friction welded surface parallel with a fasteners longest axis) the exemplary embodiments may become more prone to creep susceptibility and fatigue life especially for thermoplastic systems at elevated temperatures. Therefore, in an aspect but without limitation, the exemplary embodiments can enhance retention and mechanical properties that rely on continuous end to end fiber reinforcement in the composite fastener part instead of the mechanical locking features. Threads, swaging elements, mechanical locks, etc. can be beneficial as well when a second aspect of the composite fastener part is able to capture the locking elements preventing lifecycle loading on these features and retaining preload/tension in one or more component in the fastened joint.

FIG. 15 shows an example of capturing and retaining preload with the threaded nut 1510 which can enhance preload generation while maintaining the retention of the flared head 1515 without the need for a center mandrel, break point, and locking collar. Within the embodiment pictured in FIG. 15 the threaded mandrel and nut function to generate primary preload by pulling tension in the mandrel. It has been discussed that the preload held by the nut in a composite system is susceptible to lower strength, creep, and fatigue life especially in tension applications so the improvement to capture preload through a molded or flared head over a nut or mechanical lock point can enhance a functional structural fastener in a composite system that relies on the discussed mechanical features.

As the aerospace industry continues to grow with increased demand and production rates the ability to automate assembly level details is highly attractive. Therefore, embodiments are presented with automation in mind for both blind and dual access joints. Whether a joint is truly accessible from both sides or not - from an automation perspective the ability to perform installation on one side of a joint is highly attractive. Automated assembly prefers blind installation for two primary reasons. One being constraints where dual side access is not permissible due to limited shop space as pictured in FIG. 16 or simply due to constraints of the part geometry not allowing two side access. The other primary reason comes from the added complexity of requiring operations on two sides of a joint where multiple robotic systems are required to operate on opposing sides of a joint sometimes with no line of sight between the two.

Most fasteners and hardware components in aerospace assemblies are ‘wet’ installed meaning that a paste adhesive or sealant is applied to the mandrel of a fastener prior to installation which is intended to close gaps in the system and seal the joint from moisture as well as other various advantageous characteristics. The adhesives used in wet installation are not considered structural or load bearing so embodiments are presented to function with or without wet installation, though the combination of wet installation and composite hardware components has certain advantages. Dual access fasteners may be wet installed and cured manually on one side of a joint such that they are held in place prior to installation forces acting on the hardware so that automation can complete installation on the opposing side. Embodiments including center pin mandrels in a sleeve or other components which may be pulled are excellent for automation where an end effector can pull tension or preload into the fastener with a countersunk or protruding head on the other side of the joint such that there is no risk of pushing the fastener out of the installation hole as is possible with other more compressive installation forces. Even in embodiments which rely on compressive installation forces the material excited with a level of energy applied such that the polymer matrix reaches a flow state and the compressive forces required to act on the fastener will be relatively low compared to metallic hardware such as the high level of bucking force required to compress a metallic solid rivet. Additionally end effectors for automation and installation tooling may be designed such that primary compressive forces are applied to the surrounding material with minimal load applied to the fastener alleviating risk of fastener loss during installation.

Embodiments including blind fasteners and dual access fasteners according to the exemplary embodiments include end-to-end continuous fiber reinforcement in highly controlled orientations as well as further design elements to generate preload in a joint and retain the preload throughout the lifecycle of the fastener/hardware.

The exemplary embodiments show various geometries, fiber reinforcement orientations, installation techniques, use cases, and essential forces/loads where these characteristics may be combined in multiple ways to create a functioning composite fastener part, system, or component. Embodiments are not limited to the combinations shown in the figures which are merely representative and include various combinations thereof.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases "at least one", "one or more", and "and/or" are open-ended expressions that are both conjunctive and disjunctive in operation. For example, each of the expressions "at least one of A, B and C", "at least one of A, B, or C", "one or more of A, B, and C", "one or more of A, B, or C" and "A, B, and/or C" means A alone, B alone, C alone, A and B together, A and C together, B and C together, or A, B and C together.

Approximating language, as used herein throughout the specification and claims, may be applied to modify any quantitative representation that could permissibly vary without resulting in a change in the basic function to which it is related. Accordingly, a value modified by a term such as "about" or “approximately” is not to be limited to the precise value specified. Such approximating language may refer to the specific value and/or may include a range of values that may have the same impact or effect as understood by persons of ordinary skill in the art field. For example, approximating language may include a range of +/-10%, +/-5%, or +/-3%. The term “substantially” as used herein is used in the common way understood by persons of skill in the art field with regard to patents, and may in some instances function as approximating language. In some instances, the approximating language may correspond to the precision of an instrument for measuring the value.

In this specification and the claims that follow, reference will be made to a number of terms that have the following meanings. The terms "a" (or "an") and "the" refer to one or more of that entity, thereby including plural referents unless the context clearly dictates otherwise. As such, the terms "a" (or "an"), "one or more" and "at least one" can be used interchangeably herein. Furthermore, references to "one embodiment", "some embodiments", "an embodiment" and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as "about" is not to be limited to the precise value specified. In some instances, the approximating language may correspond to the precision of an instrument for measuring the value. Terms such as "first," "second," "upper," "lower" etc. are used to identify one element from another, and unless otherwise specified are not meant to refer to a particular order or number of elements.

As used herein, the terms "may" and "may be" indicate a possibility of an occurrence within a set of circumstances; a possession of a specified property, characteristic or function; and/or qualify another verb by expressing one or more of an ability, capability, or possibility associated with the qualified verb. Accordingly, usage of "may" and "may be" indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur - this distinction is captured by the terms "may" and "may be."

As used in the claims, the word "comprises" and its grammatical variants logically also subtend and include phrases of varying and differing extent such as for example, but not limited thereto, "consisting essentially of" and "consisting of." Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms "determine", "calculate" and "compute," and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A fastener apparatus comprising:
a first part configured to be attached to a second part; and
the first part includes a polymer including a plurality of continuous fibers that continuously extend from one end of the first part to another end of the first part.

2. The fastener apparatus according to claim 1, wherein:
the first part includes a first section and a second section having a different shape from the first section; and
the plurality of continuous fibers continuously extend from the first section to the second section.

3. The fastener apparatus according to claim 2, wherein:
the first section is configured as a mandrel and the second section is configured as a head.

4. The fastener apparatus according to claim 1, wherein:
the first part is configured as a solid rivet or an insert.

5. The fastener apparatus according to claim 1, wherein:
the second part includes another polymer including another plurality of continuous fibers that continuously extend from one end of the second part to another end of the second part.

6. The fastener apparatus according to claim 1, wherein:
the plurality of continuous fibers extend in parallel to a longest axis of the first part.

7. A fastener apparatus comprising:
a first part configured to be attached to a second part; and
the first part includes a polymer including a plurality of continuous fibers that wraps completely around a center of a longest dimension of the first part.

8. The fastener apparatus according to claim 7, wherein the first part includes a polymer including a plurality of continuous fibers arranged in a helical path that curves around a center of a longest dimension of the first part.

9. The fastener apparatus according to claim 7, wherein the first part includes a first region and a second region; and
the first region includes a polymer including a plurality of continuous fibers that extend continuously from one end of the first region to another end of the first region.

10. The fastener according to claim 9, wherein the first region is a non-deformable region, and the second region is a deformable region.

11. A fastener apparatus comprising:
a first part configured to be attached to a second part; and
the first part includes a polymer including a plurality of continuous fibers that continuously extend along a single common orientation direction with respect to a central axis of a longest dimension of the first part.

12. The fastener apparatus according to claim 11, wherein the first part includes a polymer including a plurality of continuous fibers that continuously extend along a plurality of orientation directions, the number of the plurality of orientation directions is less than or equal to 5 and greater than 1.

13. The fastener apparatus according to claim 8, wherein the number of the plurality of orientation directions is less than or equal to 3 and greater than 1.
